(19) United States
(12) Patent Application Publication
(10) Pub. No.: US 2018/0285993 A1
(43) Pub. Date: Oct. 4, 2018

(54) AUTOMATIC ROUTING TRANSACTION RECORDS OVER AN EXTRANET

(71) Applicant: Experian Health, Inc., Franklin, TN (US)

(72) Inventors: Steven B. Millhouse, Jordan, MN (US); Eric Ingram, Austin, TX (US); Ian Flores, San Antonio, TX (US); Chris Matelski, Saint Paul, MN (US); Colin Kriwox, Cornwall, VT (US)

(73) Assignee: Experian Health, Inc., Franklin, TN (US)

(21) Appl. No.: 15/475,653

(22) Filed: Mar. 31, 2017

(51) Int. Cl. G06Q 50/18; G06F 17/30

(52) U.S. Cl. CPC G06Q 50/18; G06F 17/30283

(57) ABSTRACT

A system and method for assigning and distributing transaction records over a network. A rules engine is programmed to apply one or more rules to each agent record and identify each second party satisfying each rule. At least one of the rules is a first rule determining if a jurisdiction identified in each of the agent records matches the jurisdiction identified in the transaction record. The assignment engine is programmed to assign the transaction record to one of the second parties. The assigned second party is one of the agents identified by the rules engine.

### BACKGROUND

It seems services are getting more and more expensive every year. These increases present a particular problem for many people who have significant obligations, but have little or no pre-arranged assistance (e.g., insurance, savings). Unfortunately, such people often have limited wealth and difficulty paying bills from their healthcare providers. At the same time, service providers are facing ever rising costs for labor, equipment, real estate, etc.

As a result, service providers occasionally turn over unmet obligations from consumers to recovery agents after a reasonable, good-faith effort to recover from them. While service providers must occasional resort to recovery agents, service providers exist to serve and care for people, so they want to turn ongoing transaction records over only to recovery agents that comply with laws and regulations and that do not use unethical recovery tactics. A problem is that service providers commonly have consumers and recovery agents all over the country and it is very difficult, if not impossible, to track the performance and compliance of the recovery agents they might use.

### SUMMARY

One aspect of this patent document is a system for assigning and distributing transaction records over a network. The system comprises a data store storing rules, data for transaction records, and agent records. Each transaction record identifies a jurisdiction related to the transaction record, and each agent record identifies an agent and a jurisdiction in which the agent is licensed to operate. A server is in data communication with an extranet and the data store. The server is programmed to receive transaction records from a first party over the extranet, store the transaction records in the data store, and selectively distribute the transaction records to a second party over the extranet. The second party is an agent. The server is remote from the first party and the second party. A processor is in data communication with the data store and the server. The processor is programmed with a rules engine and an assignment engine. The rules engine is programmed to apply one or more rules to each agent record and identify each second party satisfying each rule. At least one of the rules is a first rule determining if a jurisdiction identified in each of the agent records matches the jurisdiction identified in the transaction record. The assignment engine programmed to assign the transaction record to one of the second parties. The assigned second party is one of the agents identified by the rules engine.

Another aspect of this patent document is a method for assigning and distributing transaction records over a network. The method comprises receiving a plurality of agent records, each agent record identifying an agent and data relating to the agent, the data comprising one or more jurisdictions in which the identified agent is licensed; receiving a transaction record from a first party, the transaction record identifying a jurisdiction; applying one or more rules to each agent record, placing the agent identified in the data record on a compliance list of agents upon each of the rules being satisfied by data in the agent record, the one or more rules comprising a first rule determining if a jurisdiction identified in the agent record matches the jurisdiction identified in the transaction record; assigning the transaction record to one of the agents in the compliance list of agents; and delivering the transaction record to the assigned agent.

### BRIEF DESCRIPTION OF THE DRAWINGS

FIG. 1 is a schematic block diagram illustrating an extranet-based system for automatically evaluating recovery agent compliance and automatically distributing transaction records.

FIG. 2 is a schematic block diagram illustrating an example embodiment of a compliance management system illustrated in FIG. 1.

FIG. 3 is a flowchart of operations performed by the compliance management system illustrated in FIG. 2.

FIG. 4 is a flowchart illustrating more detail about an operation illustrated in FIG. 3.

FIG. 5 is a flowchart illustrating an example operation for the compliance management system illustrated in FIGS. 1-4.

FIG. 6 is a schematic block diagram illustrating a computing device included in the network and systems illustrated in FIGS. 1 and 2.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

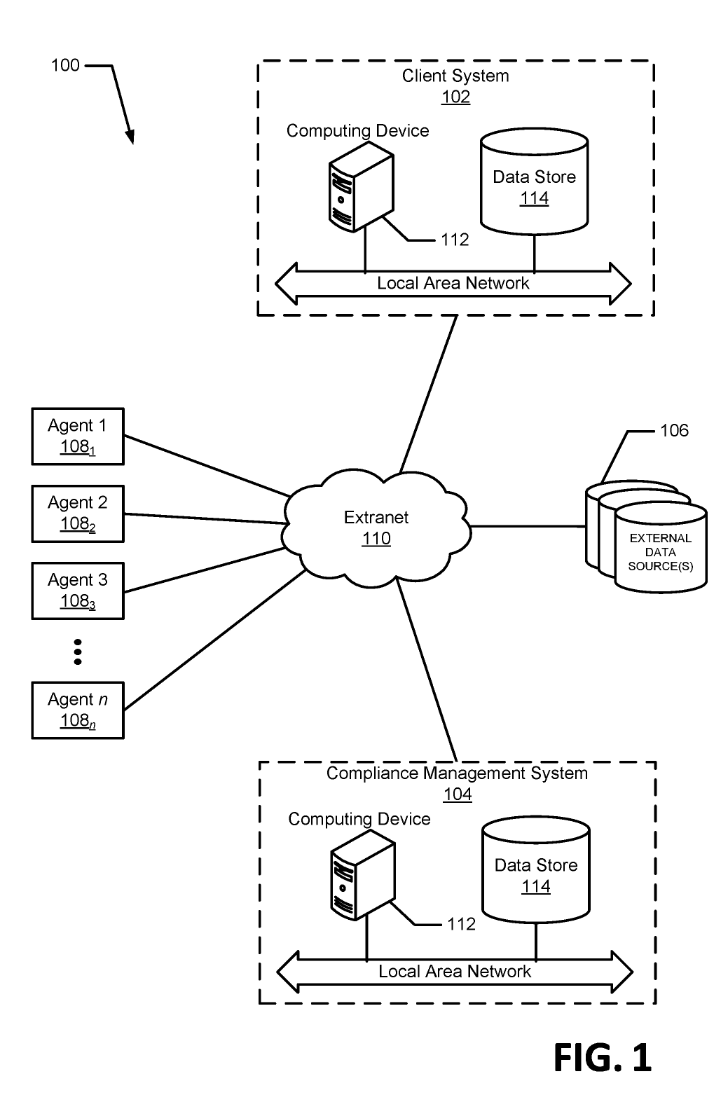

FIG. 1 is a schematic block diagram illustrating an extranet-based system 100 for automatically evaluating recovery agent compliance and automatically distributing transaction records. Systems within the extranet-based system 100 exchange data and perform analytics to evaluate the performance of recovery agents, determine the compliance of recovery agents with laws, regulations, and ethical business practices, and assign transaction records from clients to performing and compliant recovery agents.

The extranet-based system 100 includes a client system 102, a compliance management system 104, external data sources 106, recovery agent 108₁-108ₙ, and an extranet 110. Each of the systems 102, 104, 108₁-108ₙ include one or more computing devices 112 and one or more data stores 114. The systems 102, 104, 108₁-108ₙ are in data communication with the extranet 110 to monitor the performance and compliance of the recovery agents and to automatically assign and route transaction records to compliant recovery agents. In an alternative embodiment, the compliance management system 104 can be integrated with the client system 102. The extranet 110 can be any type of public or private data network for communicating data between various systems in the extranet 110 that belong to different entities and are located at different geographic locations. The Internet is an example of one possible extranet 110.

The client system 102 stores a plurality of records including transaction records, which include medical records, services-rendered records, goods-provided records, and accounting records (e.g., accounts receivable records) showing money or other obligations owed from consumers (e.g., patients, customers) and other people and entities. The client will attempt to recover the balance of the transaction records. If recoveries are unsuccessful, the client may turn the transaction record over to a recovery agent for recovery. The client may assign billing or recovery to a third-party billing or recovery service, consultant, or other service provider, which then operates as a part of the client system 102. In some aspects, the client system 102 is a healthcare provider or other service provider system, but is not so limited.

The compliance management system 104 is system that tracks recovery agents 108₁-108ₙ and whether they are in compliance with laws, regulations, and ethical business practices. The compliance management system 104 also tracks performance of the recovery agents 108₁-108ₙ. In example embodiments, the compliance management system 104 tracks performance by monitoring and analyzing performance measures such as the number or percentage of transaction records on which they recover, the percentage of the obligation due they recover, other relevant performance data, or combinations thereof.

In an example embodiment, the transaction records are transferred to the compliance management system 104, which then assigns the transaction record to a recovery agent 108 and transfers the transaction record to the assigned recovery agent 108. In an alternative embodiment, when a transaction record is ready to be assigned to a recovery agent 108, the compliance management system 104 determines a recovery agent 108 to which the transaction record should be assigned and interfaces with the client system 102 to coordinate delivery of the transaction record directly from the client system 102 to the assigned recovery agents 108.

The external data source(s) 106 are sources for information relevant to determine compliance of the recovery agents 108₁-108ₙ. Examples of information that may be useful to determine compliance include the number of time a recovery agent 108 has been sued, the number of complaints filed against the recovery agent 108, whether the recovery agent 108 has a current license in the jurisdiction where the obliged consumer is located. Other examples of information that can be used to determine compliance are discussed in more detail herein. Sources for this information can include court databases listing litigation dockets, the Better Business Bureau, consumer protection agencies, attorneys general offices, and commercial databases. Additionally, news and internet postings can be reviewed and analyzed using data analytics and artificial intelligence (AI) tools.

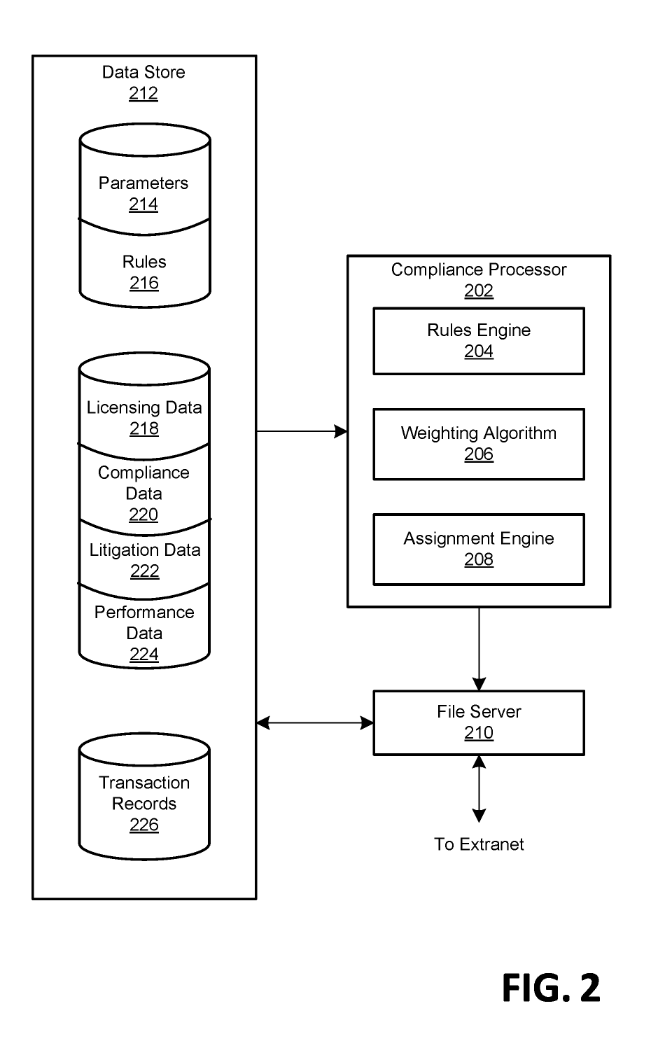

FIG. 2 is a schematic block diagram of the compliance management system 104. In this example, the compliance management system 104 includes a compliance processor 202, data store 212, and file server 210. The compliance processor 202 includes a rules engine 204, a weighting algorithm 206, and an assignment engine 208.

In various embodiments, the rules engine 204 is a set of code that applies various rules to data about the recovery agents 108₁-108ₙ and possible to the transaction records received from the client system 102. Examples of rules might include rules to: (i) determine whether a recovery agent 108 is licensed in the state where the consumer (or responsible second party) is located; (ii) determine whether a recovery agent 108 is a party to more than a threshold number of litigations; (iii) determine whether a recovery agent 108 has more than a threshold number of complaints lodged against it; (iv) determine whether there are any government investigations of a recovery agent 108; (v) determine whether an agent meets designated performance statistics; and (vi) any other rules that might be provided by the compliance management system 104 or the client.

The weighting algorithm 206 is a set of code that evaluates performance data about the compliance agents 108₁-108ₙ. The weighting algorithm 206 performs a statistical analysis of the performance data for the recovery agents 108₁-108ₙ and calculates a weight, score or other value for each performance measure of each recovery agent 108. The weighting algorithm 206 then ranks, weights, or scores each recovery agent 108 based on the weight given to their performance measures. Many different weighting techniques can be used to calculate or determine weights for the various performance measures or calculate or determine an overall weight, score, or performance rank for each recovery agent.

The assignment engine 208 is a set of code that evaluates the recovery agents 108₁-108ₙ and determines to which recovery agent 108 a transaction record should be assigned. In an alternative embodiment, the assignment engine 208 also periodically evaluates the recovery agents 108₁-108ₙ and determines whether any transaction records currently assigned to a given recovery agent 108 should be recalled and reassigned to a different recovery agent 108.

The assignment engine 208 uses the output from the rules engine 204 to determine which recovery agents 108₁-108ₙ are in compliance. The assignment engine 208 then uses the performance weight, score, or rank for each of the recovery agents 108 to assign the transaction record to a compliant recovery agent 108. The assignment engine 208 can use a variety of techniques or algorithms to assign transaction records to the recovery agents 108₁-108ₙ according to their performance. In one embodiment, for example, the assignment engine 208 assigns a certain percentage of the transaction records to a recovery agent 108 based on its performance weight, score, or rank. For example, the top performing recovery agent 108₁ would be assigned the highest percentage of transaction records, the second best performing recovery agent 108₂ would be assigned the next highest percentage of transaction records, and so on.

The compliance processor 202 then records the assignment in the data store 212 and communicates the transaction record and its assignment to the file server 210. The file server 210 sends the transaction record to the assigned recovery agent 108.

The file server 210 is a computing device that provides data communication between the compliance management system 104, the client systems 102, external data sources 106, and the recovery agents 108 via the extranet 110. The file server 210 interfaces with the compliance processor 202, the data store 212, and the extranet 110. It is programmed to at least: (i) receive transaction records, rules, parameters, and other instructions from the client system 102; (ii) request and retrieve data from the external data sources 106 regarding the recovery agents 108₁-108ₙ; (iii) receive data from the recovery agents 108₁-108ₙ; (iv) send transaction records, data, and instructions to the recovery agents 108₁-108ₙ; and (v) store data received from the extranet 110 in the data store 212.

The data store 212 can include any form of computer readable memory storage device that forms a part of a computing device 112 or devices executing the compliance processor 202. Alternatively, the data store 212 can include separate or secondary storage hardware in data communication within the computing device 112 executing the compliance processor 202. In an alternative embodiment, the data store 212 can be a cloud-based storage system that is separate and remote from the compliance management system 104, but is in data communication with the compliance management system 104 through the extranet 110.

The data store 212 stores licensing data 218, compliance data 220, litigation data 222, performance data 224, rules 216, parameters 214, and transaction records 226. The licensing data 218 identifies the state(s) in which the recovery agents 108₁-108ₙ are licensed. It also may store particular details about the recovery agents' 108₁-108ₙ licenses and license statuses. Because the licensing status of the recovery agents 108₁-108ₙ can change, the compliance processor 202 can periodically update the licensing data 218 for the recovery agents 108₁-108ₙ. Licensing data 218 can be manually entered into the data store 212. Alternatively, the compliance processor 202 can automatically contact state licensing agents and download the licensing data 218.

The litigation data 222 identify whether recovery agents 108₁-108ₙ are involved in litigation. For each recovery agent 108 involved in litigation, the litigation data 222 can include whether it is a defendant or a plaintiff; the cause of action (i.e., why the recovery agent 108 was/brought sued) for each litigation; or the status of the litigation; whether the recovery agent 108 won, lost, or settled the litigation. Additionally, the litigation data 222 can include all known litigations or just litigations that were active within a defined time frame. The litigation data 222 can be manually entered into the data store 212. Alternatively, the compliance processor 202 can download the litigation data 222 from third-party data sources 106 such as court docketing systems or commercial databases, such as those provided by Thompson Reuters.

The compliance data 220 includes other data used to determine whether the recovery agents 108 are compliant with laws, regulations, and ethical conduct. Examples of such additional information includes the number and type of complaints lodged against a recovery agent 108 and data about any government investigations of a recovery agent 108. The compliance data 220 also can include the complaint status for each of the recovery agents 108₁-108ₙ, such as whether the recovery agents 108₁-108ₙ are in compliance.

The performance data 224 includes performance measures or data indicative of how well a recovery agent 108 is performing. Examples of performance data 224 include: (i) the number or percentage of transaction records for which each agent 108 recovers (in whole or in part); (ii) the number or percentage of transaction records for which each agent 108 recovers in whole; (iii) the number or percentage of transaction records for which the agent 108 negotiates a settlement plan; (iv) the average (e.g., mean) for the percentage recovered for each transaction record recovered; (v) the total amount that the agent 108 recovers for all of the transaction records it recovers; and (vi) the fees charged by each recovery agent 108. The performance data 224 also can include the results of the performance analysis for each of recovery agents 108₁-108ₙ such as the weights or values calculated for each performance measure, and an overall weight, rank, or score calculated or determined for each of the recovery agents 108₁-108ₙ.

The rules 216 are statements of code that define or control operation of the various components of the compliance management system 104 and compliance processor 202. Examples of rules 216 include rules: defining how to allocate transaction records according their performance; defining which performance measures to use in the weighting algorithm; defining which compliance data 220 to use when determining whether a recovery agent 108 is compliant; defining the age at which a transaction record is to be assigned to a recovery agent 108; defining the type or characteristics of a transaction record that a recovery agent 108 is willing to accept; defining whether a transaction record should be recalled form a recovery agent 108 if it goes out of compliance; and defining any recovery agents 108 that a client is willing to, or not willing to, have recover its transaction records. The rules may be defined by the client, the entity managing the compliance management system 104, or even the recovery agents 108₁-108ₙ.

The parameters 214 include values or other criteria that define operation of the compliance processor 202. Examples include percentages used to determine how many transaction records to assign a recovery agents 108 having a determined performance weight, score, or rank; the age at which a transaction record is to be assigned to a recovery agents 108; parameters used in determining performance of the recovery agents 108₁-108ₙ; the threshold number of incidents for each compliance factor at which recovery agents 108₁-108ₙ are deemed not in compliance; and a time frame for compliance events or performance measures used to evaluate the recovery agents 108₁-108ₙ. In an example embodiment, the parameters 214 can be the same for all clients and all transaction records. In other embodiments, the parameters can vary for the clients, the recovery agents 108₁-108ₙ, and transaction records having different characteristics such as the transactional and demographic profiles of the consumer.

The transaction records 226 are the ongoing transaction records received from the client. In alternative embodiments, the compliance management system 104 and data store 212 do not store any transaction records 226. An example of such an alternative embodiment is providing the compliance management system 104 to clients in a software as a service (SAAS) environment in which the compliance management system 104 is a centrally hosted cloud- or network-based service and is licensed to the clients.

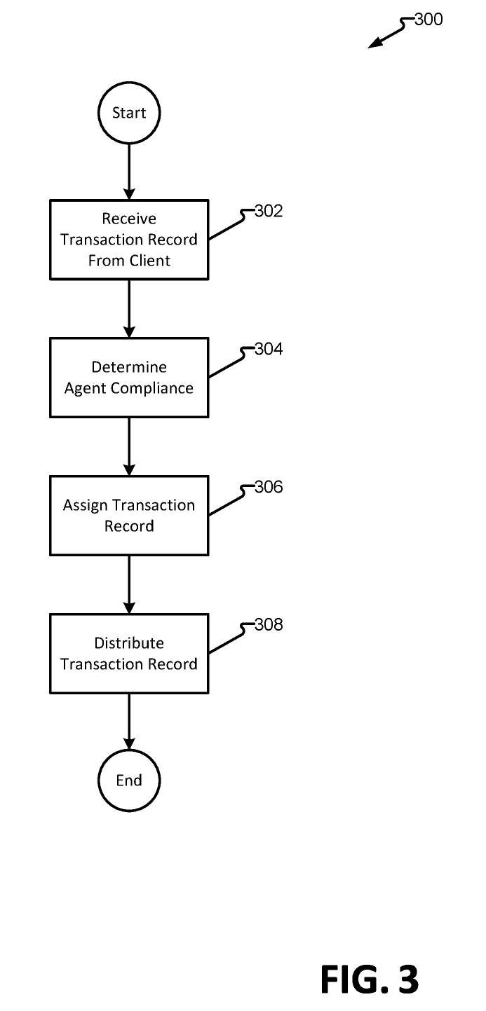

FIG. 3 is a flowchart illustrating an example method 300 for operation of the extranet-based system 100 for automatically evaluating recovery agent compliance and automatically distributing transaction records. The flowchart starts when the compliance management system 104 receives transaction records 226 from the clients. OPERATION 302. The file server 210 stores the transaction record 226 in the data store 212 so it can be processed by the compliance processor 202. In an alternative embodiment where the compliance management system 104 is used in a SAAS environment, the client logs into the compliance management system 104 or otherwise send instructions for the compliance processor 202 to process its transaction records.

The compliance processor 202 then analyzes or evaluates each of the recovery agents 108₁-108ₙ and determines which agents are in compliance and eligible to recover the transaction record. OPERATION 304. Determining compliance includes identifying the recovery agents 108₁-108ₙ properly licensed to handle the transaction record and evaluating other factors related to the recovery agents 108₁-108ₙ such as litigations and complaints as disclosed in more detail herein. In an alternative embodiment, the compliance processor also determines whether the recovery agents 108₁-108ₙ meet a minimum or threshold level of performance. Because compliance can change frequently, one example embodiment determines compliance of the recovery agents 108₁-108ₙ each time it receives a transaction record to assign to a recovery agent 108.

In an alternative embodiment, the compliance processor 202 periodically evaluates compliance for all of the recovery agents 108₁-108ₙ. In this alternative embodiment, the compliance processor 202 evaluates compliance of the recovery agents 108₁-108ₙ relatively frequently, such as twice a day, daily, weekly, or monthly, although the period can be shorter than twice a day or longer than a month. Additionally, in this alternative embodiment, the data store 212 stores the compliance status for each of the recovery agents 108₁-108ₙ as compliance data 220. When assigning a transaction record, the compliance processor 202 checks the stored compliance status of the recovery agents 108₁-108ₙ and does not reevaluate all of the other compliance criteria.

After identifying the recovery agents 108₁-108ₙ that are compliant, the compliance processor 202 assigns the transaction record to one of the compliant recovery agents 108 based on its performance weighting and possibly some additional criteria, such as the number of transaction records already assigned to each of the recovery agents 108₁-108ₙ. OPERATION 306. This operation includes evaluating or weighting, scoring, or ranking performance of the compliant recovery agents 108₁-108ₙ. Because performance data 224 can constantly change, the performance evaluation can be performed each time a transaction record is received for distribution to a recovery agent 108. In an alternative embodiment, the compliance processor 202 periodically evaluates performance of the recovery agents 108₁-108ₙ and stores the overall performance weight, score, or rank for each recovery agent 108 in the data store 212. When assigning a transaction record in this alternative embodiment, the compliance processor 202 assigns the record based on the stored performance weight, score, or rank of the compliant recovery agents 108₁-108ₙ.

Once the transaction record is assigned to a recovery agent 108, the compliance processor 202 instructs the file server 210 to transfer the transaction record to the assigned recovery agent 108. OPERATION 308. In an alternative embodiment, the compliance management system 104 does not transfer the transaction record to the recovery agent 108. Instead, the compliance processor 202 instructs the file server 210 to send a notice to the assigned recovery agent 108. The assigned recovery agent 108 then logs into the compliance management system 104 to process the transaction record. Method 300 then ends.

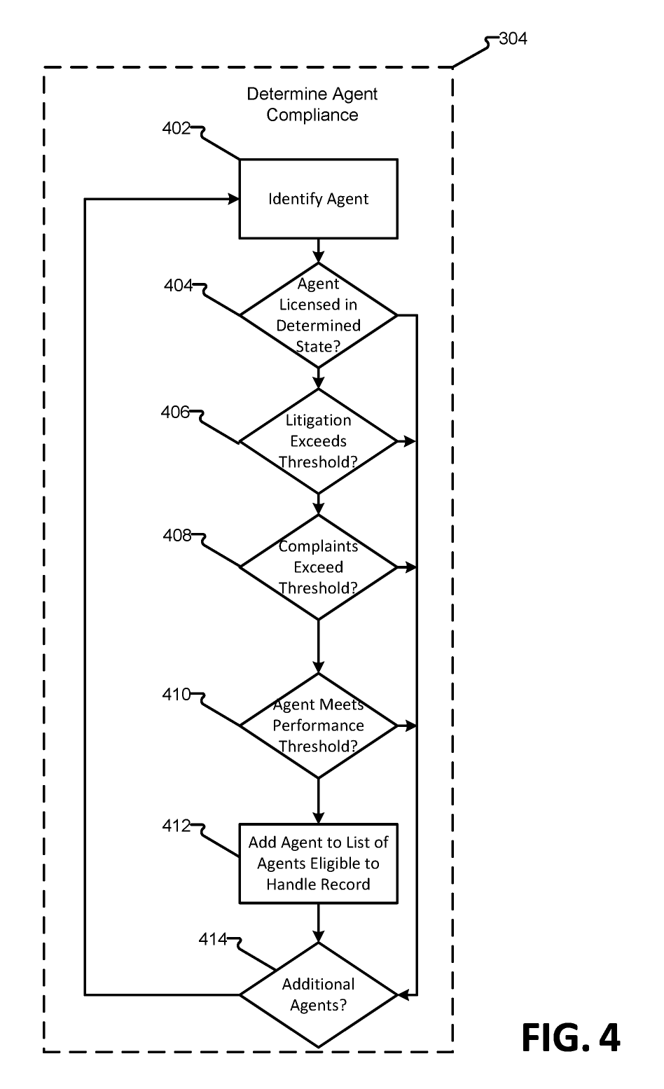

FIG. 4 is a flow chart illustrating details of OPERATION 304 of the method 300 for determining whether recovery agents 108₁-108ₙ are in compliance with laws, regulation, and ethical practices. The compliance processor 202 identifies the active recovery agents 108₁-108ₙ available to process new transaction records. OPERATION 402. For each active recovery agent 108, the compliance processor 202 determines whether the agent 108 is licensed in the state where the consumer (or other responsible party) for the transaction record resides. OPERATION 404. In various embodiments, the compliance processor 202 also can evaluate whether the recovery agent 108 has any other licenses that may be required.

The compliance processor 202 also evaluates whether the active recovery agents 108₁-108ₙ have been involved in more than a threshold number of litigations. OPERATION 406. In various embodiment, the criteria for determining the number of litigations can include factors such as the total number of litigations, the number of litigations in which the recovery agent 108 has been named a defendant, the number of litigations within a defined time frame, and other factors as discussed in more detail herein or that may otherwise be relevant to evaluating compliance.

The compliance processor 202 also evaluates the complaints lodged against the recovery agent 108. OPERATION 408. In various embodiments, the criteria for determining the number of complaints can include factors such as the total number of complaints, the number of complaints within a defined time frame, and other factors as discussed in more detail herein or that may otherwise be relevant to evaluating compliance. In alternative embodiments, the compliance processor 202 also may evaluate whether the recovery agent 108 meets a minimum threshold for performance. OPERATION 410. In different embodiments, for example, the compliance processor 202 may determine whether the weight for any of the agent's performance measures fall below a threshold value or whether the overall weight, score, or rank assigned to the recovery agent 108 falls below a threshold level.

If the recovery agent 108 meets the minimum standard for each of these compliance factors, the compliance processor 202 flags the recovery agent 108 as being eligible to receive the transaction records or adds the recovery agent 108 to a list of eligible recovery agents 108. OPERATION 412. The compliance processor 202 repeats this process for each recovery agent 108. OPERATION 414. Once all of the recovery agents 108₁-108ₙ are evaluated for compliance, the compliance processor 202 assigns the transaction record to a compliant recovery agent 108 as discussed in more detail herein. See, OPERATION 306.

In alternative embodiments, the compliance processor 202 can recall transaction records from a recovery agent 108 if the recovery agent 108 falls out of compliance. For example, the compliance processor 202 can periodically reevaluate each of the recovery agents 108₁-108ₙ. If a recovery agent 108 falls out of compliance, the compliance processor 202 is programmed to recall the transaction records assigned to the newly noncompliant recovery agent 108 and assign the recalled transaction records to a different, compliant recovery agent 108. In an alternative embodiment, if the compliance processor 202 determines a recovery agent 108 is not compliant when processing a new transaction record, the compliance processor 202 will recall the transaction records assigned to the newly non-compliant recovery agent 108 and assign its transaction records and the new transaction record to one or more other compliant recovery agents 108.

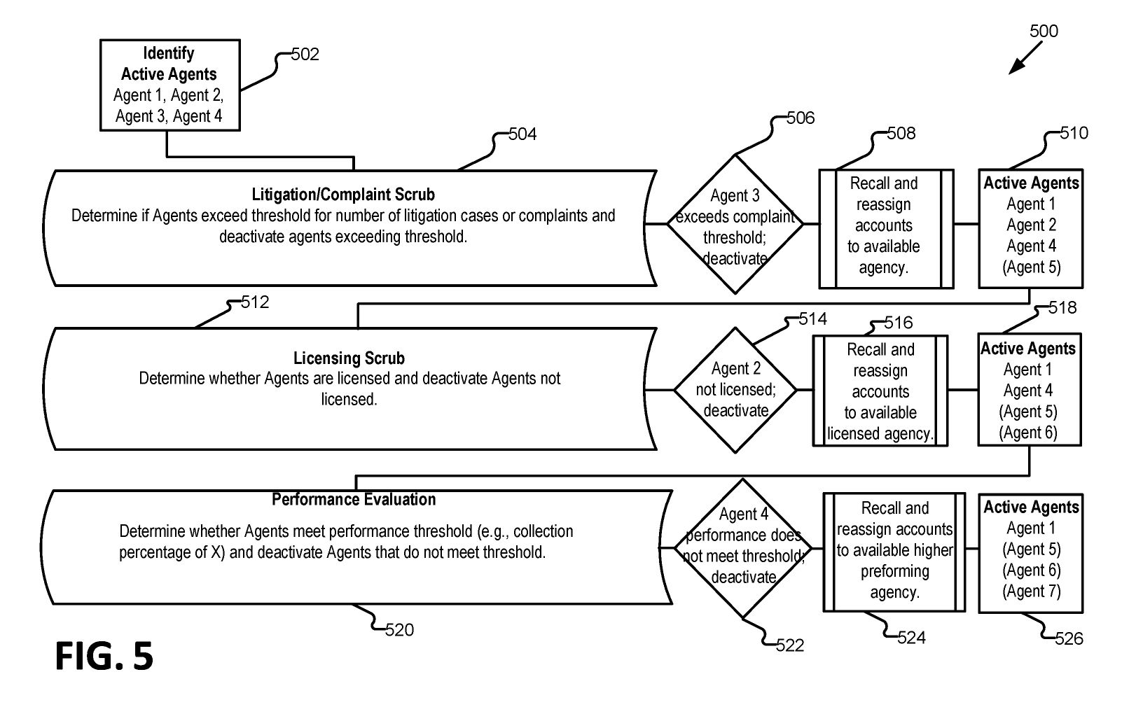

FIG. 5 is a flow chart illustrating an example for determining method 500 whether a recovery agent 108 is compliant and eligible to be assigned a new transaction record for compliance. In this example, the compliance processor 202 identifies four active recovery agents—Agent 1, Agent 2, Agent 3, and Agent 4. OPERATION 502. The active agents 108 are scrubbed or evaluated to determine whether the agents 108 exceed a threshold number of litigations or complaints. OPERATION 504. In this example, Agent 3 exceeds the threshold number of complaints and is deactivated. OPERATION 506. If Agent 3 is assigned any other transaction records, they are recalled and reassigned to one or more other compliant recovery agents 108. OPERATION 508. At this point in the processing there are three remaining active recovery agents 108 from the original set identified —Agent 1, Agent 2, and Agent 4. In some optional aspects, additional agents 108—Agent 5—are identified to return the analysis to a defined number of agents (four in the present example). OPERATION 510.

The remaining active recovery agents 108 are scrubbed or evaluated for licensing. OPERATION 512. In this example, Agent 2 is not properly licensed to handle the new transaction record and is deactivated. OPERATION 514. Additionally, any other transaction records already assigned to Agent 2 for recovery in the jurisdiction where Agent 2 is not licensed are recalled and reassigned to one or more other properly licensed and otherwise compliant recovery agents 108. OPERATION 516. There are now two active recovery agents from the original set—Agent 1 and Agent 4. In optional aspects, additional agents may be added to the set to replenish the set to a given number of agents 108 to analyze—Agent 5 and Agent 6 in the illustrated example replace Agent 3 and Agent 2 respectively. OPERATION 518.

The remaining recovery agents 108 are evaluated to determine whether they meet a minimum performance threshold. OPERATION 520. In this example, Agent 4 does not meet the minimum performance threshold and it is deactivated. OPERATION 522. Additionally, any other transaction records already assigned to Agent 4 for recovery are recalled and assigned to one or more other recovery agents 108 that meet the minimum performance threshold. OPERATION 524. There remains one recovery agent from the original set—Agent 1—that remains in compliance and active. The new transaction record is assigned to Agent 1 in aspects where the set of agents is not replenished. In aspects where the set of agents is replenished, the other agents—Agent 5, Agent 6, and Agent 7 in the current example—the agents 108 will be evaluated according to method 500 until a set is established having a requisite number of agents 108, or all available agents are evaluated, and the transactions will be assigned to the agents 108 according to a schedule or weighted assignment scheme. OPERATION 526.

FIG. 5 illustrates one of many possible embodiments for operating the compliance processor 202 and the extranet-based system 100 for automatically evaluating recovery agent compliance and automatically distributing transaction records. There are many other possible embodiment including those discussed herein in more detail.

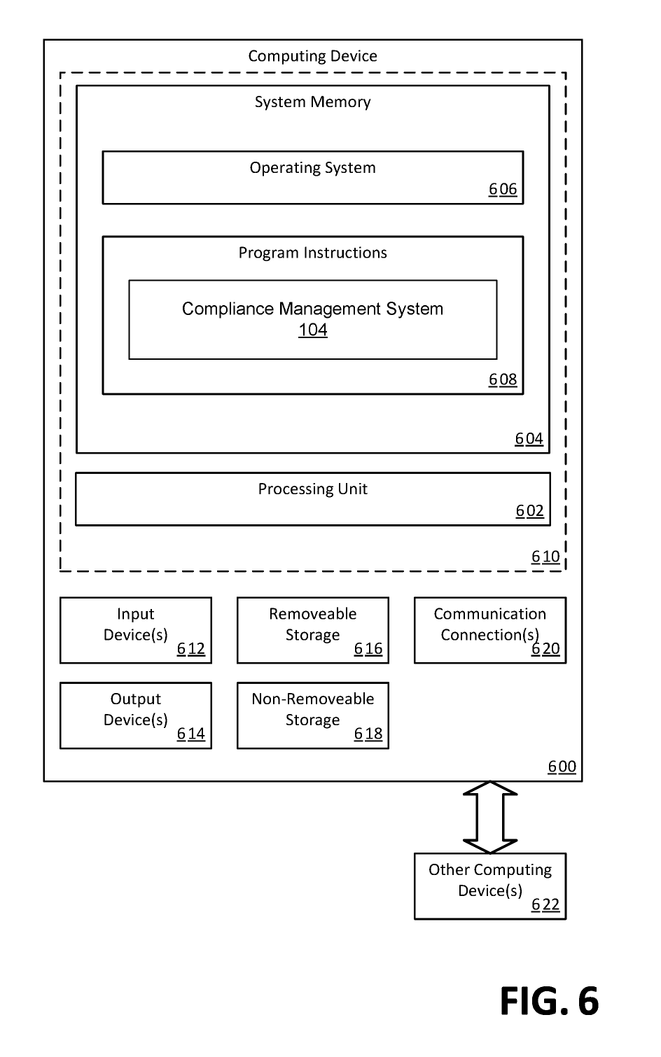

FIG. 6 is a schematic block diagram illustrating components of an example computing device 600 (e.g., computing device 112) with which aspects may be practiced. The computing device 600 may include at least one processing unit 602 and a system memory 604. The system memory 604 may include volatile (e.g., random access memory (RAM)), non-volatile (e.g. read-only memory (ROM)), flash memory, or any combination thereof. System memory 604 may include an operating system 606, one or more program instructions 608, and may include sufficient computer-executable instructions for operating the extranet-based system 100, including all of the functionality and operations disclosed herein. Operating system 606, for example, may be suitable for controlling the operation of the computing device 600. Furthermore, aspects may be practiced in conjunction with a graphics library, other operating systems, or any other application program and is not limited to any particular application or system. This basic configuration is illustrated by those components within a dashed line 610. The computing device 600 also may include one or more input device(s) 612 (keyboard, mouse, pen, touch input device, etc.) and one or more output device(s) 614 (e.g., display, speakers, a printer, etc.).

The computing device 600 also may include additional data storage devices (removable or non-removable) such as, for example, magnetic disks, optical disks, or tape. Such additional storage is illustrated by a removable storage 616 and a non-removable storage 618. Computing device 600 also may contain a communication connection 620 that may allow computing device 600 to communicate with other computing devices 622, such as over a network in a distributed computing environment, for example, an intranet or an extranet such as the Internet. The communication connection 620 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including the file server 210, hand-held devices, multiprocessor systems, microprocessor-based or programmable user electronics, minicomputers, mainframe computers, and the like. Aspects may also be practiced in distributed computing or server environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general-purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data also can be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media do not include computer-readable transmission media. Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 600 or any other computing devices 622, in combination with computing device 600, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of example embodiments in the present application, one skilled in the art may envision variations, modifications, and alternate embodiments falling within the spirit and scope of the claims appended hereto.

The claims are:

1. A system for assigning and distributing transaction records over a network, the system comprising:
a data store, the data store storing rules, data for transaction records, and agent records, each transaction record identifying a jurisdiction related to the transaction record, each agent record identifying an agent and a jurisdiction in which the agent is licensed to operate;
a server, the server in data communication with an extranet and the data store, the server programmed to receive transaction records from a first party over the extranet, store the transaction records in the data store, and selectively distribute the transaction records to a second party over the extranet, the second party being an agent, the server being remote from the first party and the second party; and
a processor in data communication with the data store and the server, the processor programmed with a rules engine and an assignment engine, the rules engine programmed to apply one or more rules to each agent record and identify each second party satisfying each rule, at least one of the rules being a first rule determining if a jurisdiction identified in each of the agent records matches the jurisdiction identified in the transaction record, the assignment engine programmed to assign the transaction record to one of the second parties, the assigned second party being one of the agents identified by the rules engine.

2. The system of claim 1 wherein at least one of the rules is a second rule determining if a number of complaints identified in the agent record is below a complaint threshold value.

3. The system of claim 2 wherein the data store stores parameters, at least one of the parameters being the complaint threshold value.

4. The system of claim 1 wherein at least one of the rules is a third rule determining if a number of litigations naming the agent as a defendant is below a litigation threshold value.

5. The system of claim 4 wherein the data store stores parameters, at least one of the parameters being the litigation threshold value.

6. The system of claim 1 wherein:
at least one of the rules is a conditional statement;
the server is further programmed to receive a data file from the first party, the data file comprising one or more parameters, at least one of the parameters defining a condition for the conditional statement; and
the data store stores the parameters, at least one of the stored parameters being related to the first party.

7. The system of claim 1 wherein the assignment engine is further programmed to recall one or more transaction records from the second party upon the second party failing to satisfy a condition related to one or more of the rules.

8. The system of claim 7 wherein the second party has an agent data store remote from the system the agent data store storing the assigned agent record, the assignment engine is further programmed to recall one or more transaction records from the second party by deleting the recalled transaction record from the agent data server.

9. A method for assigning and distributing transaction records over a network, the method comprising:
receiving a plurality of agent records, each agent record identifying an agent and data relating to the agent, the data comprising one or more jurisdictions in which the identified agent is licensed;
receiving a transaction record from a first party, the transaction record identifying a jurisdiction;
applying one or more rules to each agent record, placing the agent identified in the data record on a compliance list of agents upon each of the rules being satisfied by data in the agent record, the one or more rules comprising a first rule determining if a jurisdiction identified in the agent record matches the jurisdiction identified in the transaction record;
assigning the transaction record to one of the agents in the compliance list of agents; and
delivering the transaction record to the assigned agent.

10. The method of claim 9 wherein applying one or more rules to each agent record comprises:
executing a second rule to determine if a number of complaints identified in the agent record is below a complaint threshold value.

11. The method of claim 10 wherein applying one or more rules to each agent record comprises:
executing a third rule to determine if a number of litigations naming the agent as a defendant is below a litigation threshold value.

12. The method of claim 11 further comprising receiving a data file from the first party, the data file comprising two or more parameters, at least one of the parameters being a complaint threshold value and at least one of the parameters being a litigation threshold value.

13. The method of claim 9 further comprising:
reapplying one or more rules to each agent record on the compliance list of agents; and
upon at least one of the rules failing to be satisfied by data in an agent record while reapplying one or more rules to each agent record, recalling the transaction records assigned to the agent identified in the agent record failing to satisfying all of the rules.

14. A method for assigning and distributing transaction records over a network, the method comprising:
receiving a plurality of agent records, each agent record identifying an agent and data relating to the agent, the data comprising one or more jurisdictions in which the identified agent is licensed; and
applying one or more rules to each agent record including a first rule determining a jurisdiction identified in the agent record, placing each agent record satisfying each of the one or more rules on a compliance list of agents.

15. The method of claim 14 wherein applying one or more rules to each agent record includes applying a second rule to determine if a number of complaints identified in the agent record is below a complaint threshold value and a third rule to determine if a number of litigations naming the agent as a defendant is below a litigation threshold value.

16. The method of claim 15 further comprising receiving a data file from a remote party, the data file comprising two or more parameters, at least one of the parameters being a complaint threshold value and at least one of the parameters being a litigation threshold value.

17. The method of claim 14 further comprising:
receiving a transaction record from a first party, the transaction record identifying a jurisdiction;
determining which agents on the compliance list of agents are licensed in the jurisdiction identified in the transaction record;
assigning the transaction record to one of the determined agents on the compliance list of agents; and
delivering the transaction record to the assigned agent.

18. The method of claim 9 further comprising:
reapplying one or more rules to each agent record on the compliance list of agents; and
upon at least one of the rules failing to be satisfied by data in an agent record while reapplying one or more rules to each agent record, removing the agent from the compliance list of agents; and
if a transaction record is assigned to the agent removed from the compliance list of agents, recalling the transaction records assigned to the removed agent.

19. A computer readable storage device including computer executable instructions which, when executed by a processor, perform a method of assigning and distributing transaction records over a network, comprising:
receiving a plurality of agent records, each agent record identifying an agent and data relating to the agent, the data comprising one or more jurisdictions in which the identified agent is licensed;
receiving a transaction record from a first party, the transaction record identifying a jurisdiction;
applying one or more rules to each agent record, placing the agent identified in the data record on a compliance list of agents upon each of the rules being satisfied by data in the agent record, the one or more rules comprising a first rule determining if a jurisdiction identified in the agent record matches the jurisdiction identified in the transaction record;
assigning the transaction record to one of the agents in the compliance list of agents; and
delivering the transaction record to the assigned agent.

20. The computer readable storage device of claim 19, wherein the instructions further comprise:
reapplying one or more rules to each agent record on the compliance list of agents; and
upon at least one of the rules failing to be satisfied by data in an agent record while reapplying one or more rules to each agent record, removing the agent from the compliance list of agents; and
if a transaction record is assigned to the agent removed from the compliance list of agents, recalling the transaction records assigned to the removed agent.
